(19) United States
(12) Patent Application Publication
(10) Pub. No.: US 2010/0299369 A1
(43) Pub. Date: Nov. 25, 2010

(54) DISPLAY DEVICE, DATA CONVERSION METHOD, AND COMPUTER-READABLE MEDIUM STORING DATA CONVERSION PROGAM

(75) Inventor: Yoshihisa KUSUMOTO, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/726,570

(22) Filed: Mar. 18, 2010

(30) Foreign Application Priority Data
May 22, 2009 (JP) 2009-124577

(51) Int. Cl. G06F 1/28; G06F 17/30

(52) U.S. Cl. 707/803; 713/340

(57) ABSTRACT

A display device includes an internal battery that supplies electric power to the display device, a data acquisition portion that acquires an incompatible data file from a first storage portion, a remaining power determination portion that determines whether an amount of electric power that remains in the internal battery is at least a specified threshold value, a data conversion portion that is capable of converting the incompatible data file into an electronic file in a specified data format to create a converted file, and a storage control portion that stores the converted file in a second storage portion.

### CROSS-REFERENCE TO RELATED APPLICATION

This application claims priority to Japanese Patent Application No. 2009-124577, filed May 22, 2009, the disclosure of which is incorporated herein by reference in its entirety.

### BACKGROUND

The present disclosure relates to a display device that displays an electronic file of a specified data format, as well as to a data conversion method and a computer-readable medium that stores a data conversion program that are used by the display device.

A display device is known that displays an electronic file of a specified data format. A user desires the display device to display an electronic file of another data format that is different from the specified data format. A method is known that uses a device such as personal computer or the like to convert the electronic file of the other data format into an electronic file of the specified data format, then causes the display device to process the converted electronic file.

### SUMMARY

With the known method that is described above, in a case where the electronic file of the other data format is to be displayed on the display device, a user must use a device that is capable of converting the electronic file into the electronic file of the specified data format, which is troublesome.

Various exemplary embodiments of the general principles herein provide a display device, as well as a data conversion method and a computer-readable medium that stores a data conversion program, that can, in accordance with an amount of power remaining in an internal battery, convert an electronic file containing a large volume of data into an electronic file of the specified data format.

The exemplary embodiments provide a display device that is provided with an internal battery, a data acquisition portion, a remaining power determination portion, a data conversion portion, and a storage control portion. The internal battery supplies electric power to the display device. The data acquisition portion acquires an incompatible data file from a first storage portion that stores at least one incompatible data file, the incompatible data file being an electronic file in a data format that is different from a specified data format. The remaining power determination portion determines whether an amount of electric power that remains in the internal battery is at least a specified threshold value. The data conversion portion is capable of converting the incompatible data file that is acquired by the data acquisition portion into an electronic file in the specified data format to create a converted file. The storage control portion stores, in a second storage portion, the converted file that is created by the data conversion portion. In a case where it has been determined by the remaining power determination portion that the amount of electric power that remains in the internal battery is at least the specified threshold value, the data conversion portion converts the incompatible data file into the electronic file in the specified data format. In a case where it has been determined by the remaining power determination portion that the amount of electric power that remains in the internal battery is less than the specified threshold value, the data conversion portion does not convert the incompatible data file into the electronic file in the specified data format.

The exemplary embodiments also provide a data conversion method that is implemented in a display device that is provided with an internal battery that supplies electric power. The data conversion method includes a step of acquiring an incompatible data file from a first storage portion that stores the incompatible data file, the incompatible data file being an electronic file in a data format that is different from a specified data format. The data conversion method also includes a step of determining whether an amount of electric power that remains in the internal battery is at least a specified threshold value. The data conversion method also includes a step of converting the acquired incompatible data file into an electronic file in a specified data format to create a converted file, in a case where it has been determined that the amount of electric power that remains in the internal battery is at least the specified threshold value. The data conversion method also includes a step of storing the converted file in a second storage portion.

The exemplary embodiments also provide a computer-readable medium that stores a data conversion program. The data conversion program comprises instructions that cause a computer of a display device that is provided with an internal battery that supplies electric power to perform a step of acquiring an incompatible data file from a first storage portion that stores the incompatible data file, the incompatible data file being an electronic file in a data format that is different from a specified data format. The data conversion program also causes the computer to perform a step of determining whether an amount of electric power that remains in the internal battery is at least a specified threshold value. The data conversion program also causes the computer to perform a step of converting the acquired incompatible data file into an electronic file in a specified data format to create a converted file, in a case where it has been determined that the amount of electric power that remains in the internal battery is at least the specified threshold value. The data conversion program also causes the computer to perform a step of storing the converted file in a second storage portion.

### BRIEF DESCRIPTION OF THE DRAWINGS

Exemplary embodiments of the present disclosure will be described below in detail with reference to the accompanying drawings in which:

FIG. 1 is a system configuration diagram in which a portable terminal is connected to a multifunction device;

FIG. 2 is a block diagram that shows an electrical configuration of the portable terminal;

FIG. 3 is a flowchart that shows main processing;

FIG. 4 is a front view of the portable terminal, on which a conversion-in-progress screen is displayed;

FIG. 5 is a flowchart that shows data conversion processing;

FIG. 6 is a flowchart that shows conversion object selection processing; and

FIG. 7 is a front view of the portable terminal, on which an insufficient battery power screen is displayed.

### DETAILED DESCRIPTION OF THE EXEMPLARY EMBODIMENTS

Hereinafter, an embodiment that embodies the present disclosure will be explained with reference to the drawings. Note that the referenced drawings are used to explain technical features that the present disclosure uses. A device configuration, flowcharts of various types of processing, and the like that are shown the drawings are simply explanatory examples and do not limit the present disclosure to only those examples.

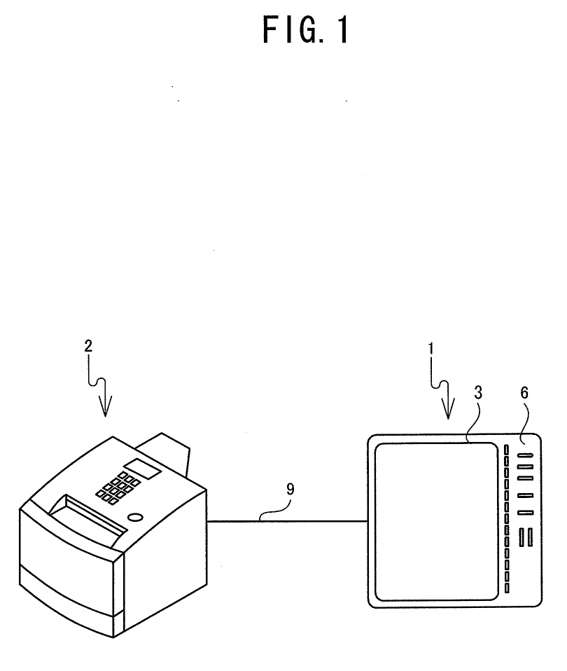

A portable terminal 1 according to the embodiment of the present disclosure will be explained with reference to FIGS. 1 to 7. The portable terminal 1 in the present embodiment can be connected to a multifunction device 2 through a Universal Serial Bus (USB) cable 9. The multifunction device 2 has the functions of a printing device, a communication device, a telephone, a facsimile machine, a scanner, and a copy machine. The portable terminal 1 can display an image based on an electronic file that is output from the multifunction device 2. The electronic file in the present embodiment includes file data that describe a document that is configured from a plurality of pages. The file data are configured from image data for as many pages as configure the document (that is, image data that describe images of individual pages).

A physical configuration of the portable terminal 1 will be explained with reference to FIG. 1. The portable terminal 1 is a lightweight, slim portable display terminal that is provided with an electrophoretic display panel 3. The basic principle of the electrophoretic display panel is that a black and white image is formed by using electrophoresis to move positively charged white electrophoretic particles and negatively charged black electrophoretic particles in a display liquid.

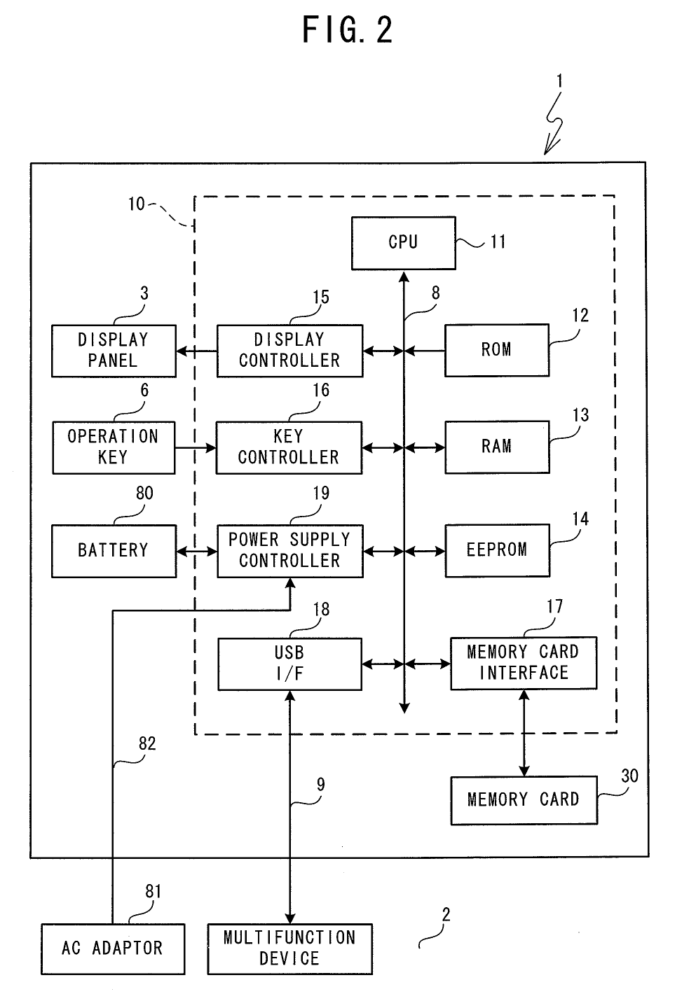

The portable terminal 1 is formed into a panel shape that is rectangular in a planar view and has a specified thickness. The display panel 3 is rectangular in the planar view and is provided on the top face of the portable terminal 1. The display panel 3 displays various types of content that are configured from text, diagrams, and the like. A user can visually recognize the content that is displayed on the display panel 3. A card slot, a USB port, a power supply connector, and the like are provided on a side face of the portable terminal 1, although these are not shown in the drawings. A memory card 30 (refer to FIG. 2) can be inserted into and removed from the card slot. A USB connector that the USB cable 9 has can be inserted into and removed from the USB port. A power supply cable 82 (refer to FIG. 2) has a terminal that can be attached to and removed from the power supply connector.

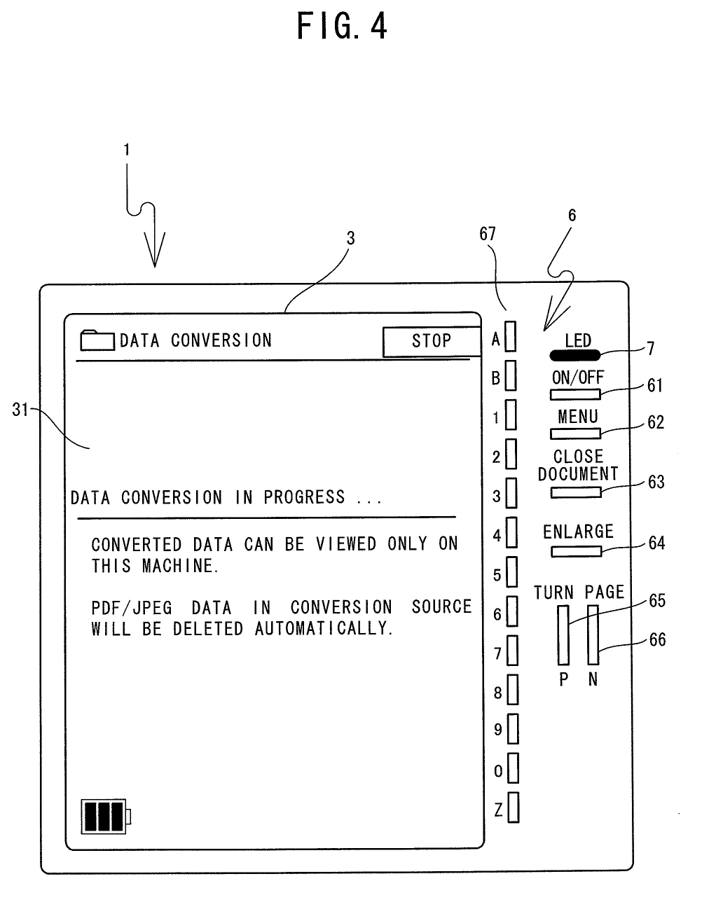

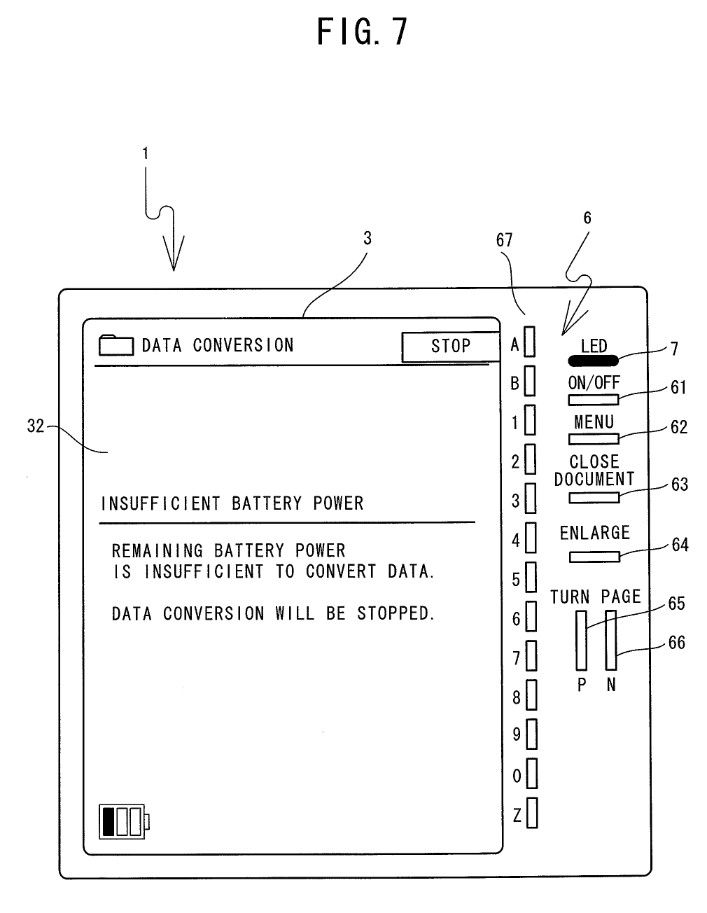

An operation portion 6 for operating the portable terminal 1 is provided to the right of the display panel 3. The operation portion 6 includes a power supply key 61, a menu key 62, a close document key 63, an enlarge key 64, a previous page key 65, a next page key 66, and character keys 67 (refer to FIGS. 4 and 7). The power supply key 61 is a key for turning the power supply of the portable terminal 1 on and off. The menu key 62 is a key for displaying a menu screen for performing electronic file selection, function setting, and the like on the portable terminal 1.

The close document key 63 is a key for closing the electronic file that is being displayed. The enlarge key 64 is a key for enlarging the image of the electronic file that is being displayed. The previous page key 65 and the next page key 66 are keys for respectively going back one page and going forward one page in the electronic file that is being displayed. The character keys 67 are keys for performing selection and input of various types of information. An LED display portion 7 (refer to FIGS. 4 and 7) is provided above the power supply key 61. The LED display portion 7 uses an LED light-emitting pattern (a color, a continuous light, a flashing light, and the like) to indicate an operating state of the portable terminal 1.

An electrical configuration of the portable terminal 1 will be explained with reference to FIG. 2. A control panel 10 of the portable terminal 1 includes a CPU 11, a ROM 12, a RAM 13, an EEPROM 14, a display controller 15, a key controller 16, a memory card interface 17, a USB interface 18, and a power supply controller 19, and these elements are connected through a bus 8. The CPU 11 performs control of the portable terminal 1. The ROM 12 stores a control program that operates the portable terminal 1 and information that pertains to the operation of the portable terminal 1. The RAM 13 is a memory that temporarily stores various types of data. The EEPROM 14 is a non-volatile memory that stores various types of data.

The display controller 15 controls image display on the display panel 3. The key controller 16 accepts a key operation from the operation portion 6. The memory card 30 that is inserted into the card slot is connected to the memory card interface 17, and the memory card interface 17 performs reading and writing of data from and to the memory card 30. The USB interface 18 includes the USB port and transmits and receives data to and from an external device (in this case, the multifunction device 2) through the USB cable 9.

The power supply controller 19 controls charging and discharging of a battery 80 that is built into the portable terminal 1 and supplies electric power. The power supply controller 19 also detects the amount of power remaining in the battery 80 and a voltage drop in the battery 80, and it controls the voltage that is supplied to the portable terminal 1. In a case where the power supply cable 82 is connected to the power supply connector that is not shown in the drawings, the power supply controller 19 receives, through an AC adaptor 81, a supply of electric power from an external power supply that is not shown in the drawings and performs charging of the battery 80 and powering of the portable terminal 1. In a case where the AC adaptor 81 is not connected to the portable terminal 1 (that is, in a case where the electric power supply is not being received from the external power supply), the portable terminal 1 is powered by the electric power that is supplied by the battery 80.

The portable terminal 1 in the present embodiment performs the image display on the display panel 3 based on an electronic file that is stored in the memory card 30 (more specifically, on image data for individual pages that are contained in the electronic file). It is acceptable for an electronic file that is output from the multifunction device 2, as illustrated in an example that is described below, to be stored in the memory card 30.

For example, the user inserts the memory card 30 into a card slot (not shown in the drawings) in the multifunction device 2. In a case where the multifunction device 2 has acquired an electronic file by reading an image on a paper medium or the like, the multifunction device 2 writes the acquired electronic file to the memory card 30. The user removes from the multifunction device 2 the memory card 30 in which the electronic file is stored and inserts it into the card slot in the portable terminal 1. This makes it possible for the portable terminal 1 to read the electronic file that has been written to the memory card 30 and to perform the image display.

The user can also insert the memory card 30 into the card slot (not shown in the drawings) in the portable terminal 1 and use the USB cable 9 to connect the portable terminal 1 and the multifunction device 2. In a case where the multifunction device 2 has acquired an electronic file by reading an image on a paper medium or the like, the multifunction device 2 transmits the acquired electronic file to the portable terminal 1 through the USB cable 9. The portable terminal 1 takes the electronic file that has been transmitted from the multifunction device 2 and writes it to the memory card 30. The transmitting and storing of the electronic file in this manner may be accomplished by one of a known function that is called scan-to-memory and another function, the function being provided in the multifunction device 2. In this case as well, it is possible for the portable terminal 1 to read the electronic file that has been written to the memory card 30 and to perform the image display.

The memory card 30 is a general-purpose storage medium that is capable of storing various types of data, not only the electronic file that is used by the portable terminal 1 for the image display. In the present embodiment, the electronic file that is written to the memory card 30 is stored in a specified folder in the memory card 30. This makes it possible to clearly distinguish the electronic file that is used by the portable terminal 1 for the image display from other data that are stored in the memory card 30.

The electronic file that is acquired by the multifunction device 2 is created in a general-purpose data format (for example, PDF, JPEG, or the like) that can be displayed on many electronic devices. In contrast, in the portable terminal 1, the image display is performed based on an electronic file of a specified data format. The specified data format is a data format that is suited to the image display by the portable terminal 1 that is performed under the display control of the electrophoretic method or the like. In a case where the electronic file that is stored in the memory card 30 is in a data format that is different from the specified data format, the portable terminal 1 converts the electronic file to an electronic file of the specified data format before performing the image display. This will be explained in detail later.

In the present embodiment, in a case where a plurality of the electronic files are stored in the memory card 30, the electronic files are selected one at a time and are sequentially converted into electronic files in the specified data format. Information (hereinafter called file selection standards) that indicates a prioritized order in which the electronic files to be converted are selected from among the plurality of the electronic files is stored in the EEPROM 14. Memory prioritization, battery prioritization, date-time prioritization, and progress prioritization are prepared as the file selection standards in advance, but these will be described separately in detail later.

In the explanation that follows, battery prioritization is set by default as the file selection standard in the EEPROM 14. Obviously, the portable terminal 1 may also be configured such that the file selection standard that the user has set in the EEPROM 14 can be changed as desired. For example, if the user presses the menu key 62, the menu screen is displayed on the display panel 3. If the user specifies the file selection standard from the menu screen, the specified file selection standard may be set in the EEPROM 14.

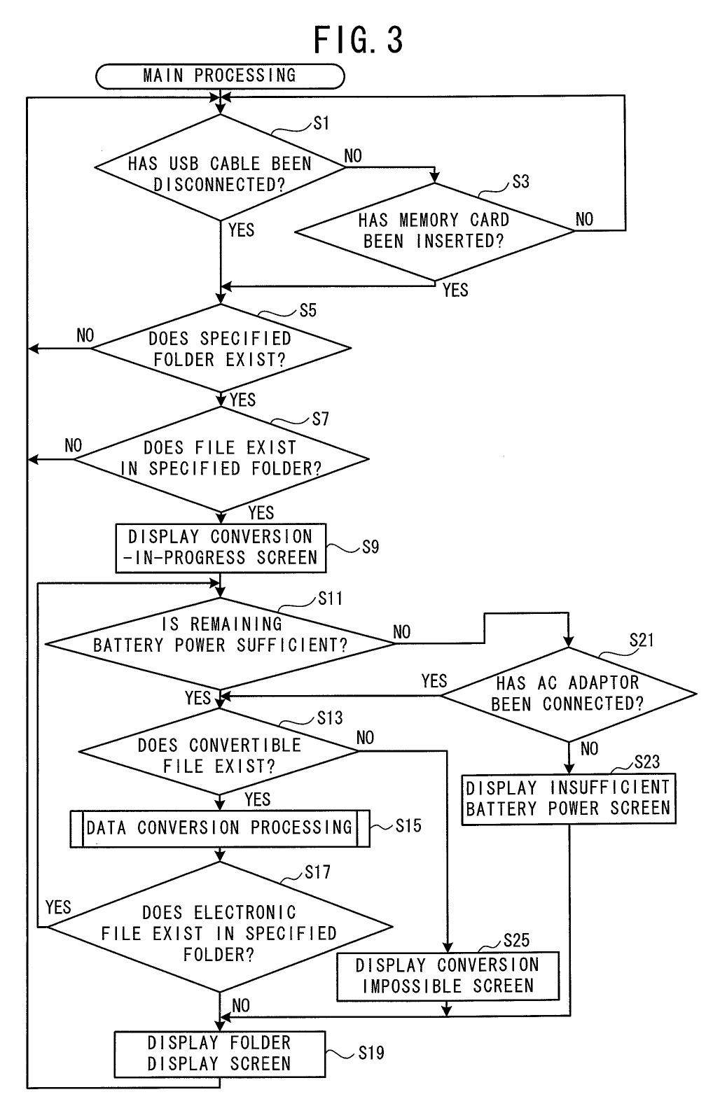

Various types of processing that are performed by the portable terminal 1 will be explained with reference to FIGS. 3 to 7. First, main processing that is performed by the portable terminal 1 will be explained with reference to FIG. 3. The main processing that is shown in FIG. 3 is performed by the CPU 11 when the power supply key 61 is turned on, based on the control program that is stored in the ROM 12.

As shown in FIG. 3, in the main processing, first, a determination is made as to whether the USB cable 9 has been disconnected from the portable terminal 1 (Step S1). At Step S1, if a change from a state in which the USB cable 9 is connected to the USB interface 18 to a state in which the USB cable 9 is not connected is detected, the determination is made that the USB cable 9 has been disconnected from the portable terminal 1 (YES at Step S1). In contrast, in a case where the USB cable 9 has not been connected to the USB interface 18, as well as in a case where the state in which the USB cable 9 is connected has not changed, the determination is made that the USB cable 9 has not been disconnected from the portable terminal 1 (NO at Step S1).

In a case where the USB cable 9 has not been disconnected from the portable terminal 1 (NO at Step S1), a determination is made as to whether the memory card 30 has been inserted into the portable terminal 1 (Step S3). At Step S3, if a change from a state in which the memory card 30 has not been connected to the memory card interface 17 to a state in which the memory card 30 has been connected is detected, the determination is made that the memory card 30 has been inserted into the portable terminal 1 (YES at Step S3). In contrast, in a case where the memory card 30 has already been connected to the memory card interface 17, as well as in a case where the state in which the memory card 30 is not connected has not changed, the determination is made that the memory card 30 has not been inserted into the portable terminal 1 (NO at Step S3).

In a case where the USB cable 9 has been disconnected from the portable terminal 1 (YES at Step S1), the possibility exists that the electronic file has been transmitted to the portable terminal 1 through the USB cable 9 and that the electronic file has been written to the memory card 30 by the portable terminal 1. In a case where the memory card 30 has been inserted into the portable terminal 1 (YES at Step S3), the possibility exists that the electronic file has been stored in the memory card 30. As described previously, the electronic file that is used for the image display by the portable terminal 1 is stored in the specified folder in the memory card 30. Accordingly, a determination is made as to whether the specified folder exists in the memory card 30 that has been connected to the memory card interface 17 (Step S5). In a case where the specified folder does exist in the memory card 30 (YES at Step S5), a determination is made as to whether the electronic file has been stored in the specified folder (Step S7).

In a case where the electronic file has been stored in the specified folder (YES at Step S7), a conversion-in-progress screen 31, an example of which is shown in FIG. 4, is displayed on the display panel 3 (Step S9). As shown in FIG. 4, a message to the effect that the converting of the data format of the electronic file is in progress (hereinafter, the data conversion is in progress) is clearly displayed on the conversion-in-progress screen 31. At this time, the emission of light from the LED display portion 7 is controlled in a specified pattern that indicates that the data conversion is in progress, and the operations of the keys in the operation portion 6 are disabled.

In the present embodiment, if a specified performed action (specifically, one of the disconnecting of the USB cable 9 and the insertion of the memory card 30) is detected, the data conversion of the electronic file is performed internally, as will be described later, without the input of a command by the user being required. If the user were to perform any operation while the data conversion is in progress, a problem such as the destruction of the electronic file, a malfunction of the portable terminal 1, or the like might occur. At Step S9, during the performing of the data conversion, it is possible to make the user aware that the data conversion is in progress by displaying the conversion-in-progress screen 31 and causing the LED display portion 7 to emit light in the specified pattern. Disabling the operations of the keys in the operation portion 6 makes it possible to prevent the user from performing an operation by mistake while the data conversion is in progress.

In a case where the memory card 30 has not been inserted into the portable terminal 1 (NO at Step S3), the processing returns to Step S1 and waits for one of the disconnecting of the USB cable 9 and the inserting of memory card 30 (Steps S1 to S3). In a case where the specified folder does not exist in the memory card 30 (NO at Step S5), and in a case where the electronic file has not been stored in the specified folder (NO at Step S7), the processing returns to Step S1 in the same manner.

After the conversion-in-progress screen 31 is displayed at Step S9, a determination is made as to whether the amount of the electric power that remains in the battery 80 is sufficient for the data conversion (Step S11). At Step S11, a determination is made as to whether the cell voltage of the battery 80 is at least a voltage threshold value that is set in advance in a specified storage area of the EEPROM 14. In the present embodiment, the battery capacity (for example, 3.7 volts) that is required in order for 200 pages' worth of the image data to be rewritten and displayed on the display panel 3 is set as the voltage threshold value. Note that the voltage threshold value can be modified.

In a case where the cell voltage of the battery 80 is at least the voltage threshold value, the possibility that an electric power insufficiency will occur during the data conversion is low, even if the data conversion of the electronic file is performed. Accordingly, a determination is made that the amount of the electric power that remains in the battery 80 is sufficient for the data conversion (YES at Step S11). In this case, a determination is made as to whether a convertible file exists in the specified folder (Step S13). The convertible file is an electronic file in a data format (for example, PDF or JPEG) that can be converted to the specified data format. In a case where a convertible file does exist in the specified folder (YES at Step S13), data conversion processing is performed that converts the convertible file into an electronic file in the specified data format (Step S15).

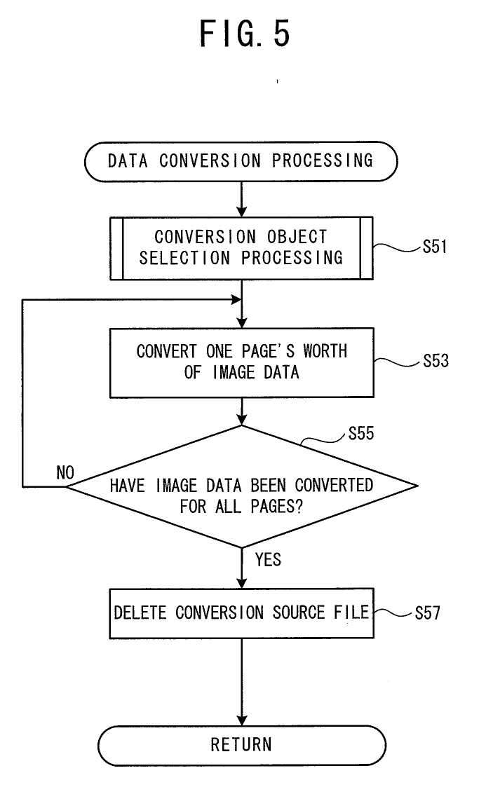

In the data conversion processing (Step S15), as shown in FIG. 5, first, conversion object selection processing is performed that selects a conversion object file (Step S51). The conversion object file is the electronic file, among the convertible files that are stored in the specified folder, that will become the object of the data conversion.

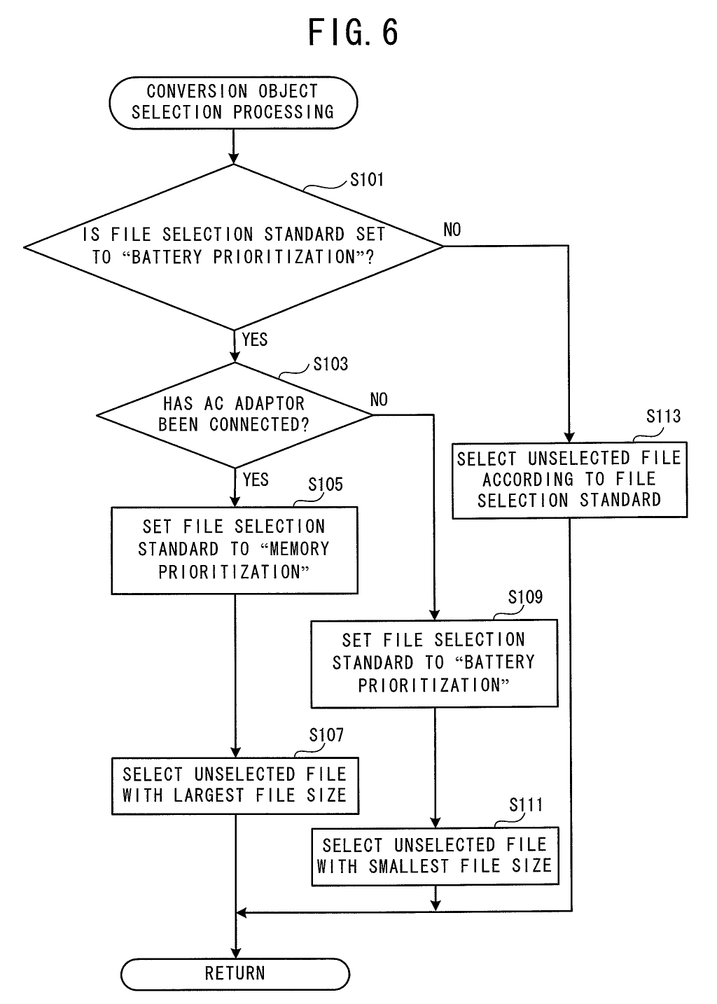

As shown in FIG. 6, in the conversion object selection processing (Step S51), first, a determination is made as to whether battery prioritization has been set as the file selection standard in the EEPROM 14 (Step S101). In a case where battery prioritization has been set as the file selection standard (YES at Step S101), a determination is made as to whether the AC adaptor 81 has been connected to the portable terminal 1 (Step S103). In a case where the electric power supply is being received from the external power supply through the power supply cable 82, a determination is made that the AC adaptor 81 has been connected to the portable terminal 1 (YES at Step S103). In that case, the file selection standard in the EEPROM 14 is set to memory prioritization instead of battery prioritization (Step S105).

After Step S105 has been performed, an unselected file is selected in the prioritized order that corresponds to the file selection standard of memory prioritization. That is, the unselected file with the largest file size is selected as the conversion object file (Step S107). The unselected file is an electronic file, among the convertible files that are stored in the specified folder, that has not yet been selected as the conversion object file by the conversion object selection processing (refer to FIG. 6).

On the other hand, in a case where the electric power supply is not being received from the external power supply, a determination is made that the AC adaptor 81 has not been connected to the portable terminal 1 (NO at Step S103). In that case, the file selection standard in the EEPROM 14 is set to battery prioritization (Step S109). In other words, at Step S109, the file selection standard in the EEPROM 14 is maintained as battery prioritization. After Step S109 has been performed, an unselected file is selected in the prioritized order that corresponds to the file selection standard of battery prioritization. That is, the unselected file with the smallest file size is selected as the conversion object file (Step S111).

In a case where battery prioritization has not been set as the file selection standard (NO at Step S101), a prioritization other than battery prioritization has been set as the file selection standard. In that case, the conversion object file is selected in the prioritized order that corresponds to the file selection standard that has been set (Step S113). Specifically, in a case where memory prioritization has been designated as the file selection standard, the conversion object file is selected in the same manner as at Step S107. In a case where date-time prioritization has been designated as the file selection standard, the unselected file with the most recent registration date-time is selected as the conversion object file. In a case where progress prioritization has been designated as the file selection standard, the unselected file with the oldest registration date-time is selected as the conversion object file.

Note that the conversion object file that is selected at one of Step S107, Step S111, and Step S113 is read from the memory card 30 into the RAM 13. After one of Step S107, Step S111, and Step S113 has been performed, the processing returns to the data conversion processing (refer to FIG. 5).

As shown in FIG. 5, after the conversion object selection processing (Step S51) has been performed, one page's worth of the image data that are contained in the conversion object file that is stored in the RAM 13 are converted into the image data in the specified data format in the RAM 13 (Step S53). The image data that are converted at Step S53 are written to an empty area of the memory card 30 and stored in a storage folder. After Step S53 has been performed, a determination is made as to whether the image data for all of the pages that are contained in the conversion object file have been converted (Step S55). In a case where unconverted image data exist among the image data that are contained in the conversion object file have been converted (NO at Step S55), the processing returns to Step S53, and the image data that correspond to the next page are converted into the image data in the specified data format in the same manner as described above. In other words, Steps S53 to S55 are performed repeatedly until no unconverted image data remain among the image data that are contained in the conversion object file. The image data that are contained in the conversion object file are thus converted sequentially into the image data in the specified data format.

In a case where the image data for all of the pages that are contained in the conversion object file have been converted (YES at Step S55), a converted file that includes the converted image data (in other words, the electronic file in the specified data format) is in a state in which it is stored in the storage folder in the memory card 30. In this case, the electronic file that is the conversion source that is stored in the specified folder in the memory card 30 (in other words, the conversion object file) is deleted (Step S57). This prevents the same electronic file from being stored in duplicate in different data formats in the memory card 30. This in turn makes it possible to ensure available capacity in the memory card 30 and to prevent a problem whereby the electronic files in the specified folder are converted an unlimited number of times. After Step S57 has been performed, the processing returns to the main processing (refer to FIG. 3).

As shown in FIG. 3, after the data conversion processing (Step S15) has been performed, a determination is made as to whether the electronic file exists in the specified folder in the memory card 30 (Step S17). In a case where the electronic file does not exist in the specified folder (NO at Step S17), a determination is made that all of the electronic files that were stored in the specified folder have been converted into the electronic files in the specified data format. In other words, a determination is made that the converted files have been created for all of the electronic files.

In that case, a folder display screen that displays a list of the converted files that are stored in the storage folder in the memory card 30 is displayed on the display panel 3 (Step S19). If the user operates the character keys 67 such that one of the converted files is selected from the folder display screen, for example, the document that is based on the selected converted file is displayed on the display panel 3. The user can thus know what the converted files are and can also select the converted files in order to perform display, editing, and the like.

In a case where the electronic file does exist in the specified folder (YES at Step S17), the processing returns to Step S11. In that case, if the amount of the electric power that remains in the battery 80 is sufficient for the data conversion, and if there is a convertible file in the specified folder, the data conversion processing is performed in the same manner as described previously (YES at Step S11; YES at Step S13; Step S15). Thus the electronic files that are stored in the specified folder are sequentially converted into the electronic files in the specified data format until the amount of the electric power that remains in the battery 80 becomes insufficient for the data conversion. Once the converted files are stored in the storage folder in the memory card 30, the electronic files that are the conversion sources are deleted from the specified folder. Thus the remaining battery capacity of the battery 80 can be utilized to the maximum extent, and the data conversion can be performed for a greater number of the electronic files.

Furthermore, the electronic files that are the conversion objects are selected in the optimal prioritized order, in accordance with the form of the electric power supply in the portable terminal 1. That is, in a case where the electric power supply is being received from the external power supply, there is no concern that the electric power will become insufficient while the data conversion of the electronic files is in progress. Therefore, the data conversion is performed sequentially, starting with the electronic file with the largest file size (YES at Step S103; Steps S105 to S107). In other words, the data conversion is performed with priority given to the electronic file for which the possibility is greatest that the file size after the data conversion will be the largest. This makes it possible to reduce the likelihood that the available capacity in the memory card 30 will be used up while the converted file is being written.

In a case where the electric power supply is not being received from the external power supply, there is concern that the electric power will become insufficient (that is, that the amount of the electric power that remains in the battery 80 will be used up) while the data conversion of the electronic files is in progress. Therefore, the data conversion is performed sequentially, starting with the electronic file with the smallest file size (NO at Step S103; Steps S109 to S111). In other words, the data conversion is performed with priority given to the electronic file for which the least amount of the electric power will be used for the data conversion. This makes it possible for the data conversion to be performed for a greater number of the electronic files before the amount of the electric power that remains in the battery 80 is used up.

Note that in a case where the cell voltage of the battery 80 is less than the voltage threshold value, a determination is made that if the data conversion of the electronic file is performed, an electric power insufficiency may occur during the data conversion. Therefore, a determination is made that the amount of the electric power that remains in the battery 80 is not sufficient for the data conversion (NO at Step S11). In that case, a determination is made as to whether the AC adaptor 81 has been connected (Step S21), in the same manner as at Step S103. In a case where the AC adaptor 81 has been connected (YES at Step S21), the data conversion can be performed using the electric power supply from the external power supply, even if the amount of the electric power that remains in the battery 80 is insufficient, so the processing advances to Step S13. Thus, even in a case where the amount of the electric power that remains in the battery 80 is not sufficient, a greater number of the electronic files can be converted by performing the data conversion while receiving the electric power supply from the external power supply.

In a case where the AC adaptor 81 has not been connected (NO at Step S21), an insufficient battery power screen 32, an example of which is shown in FIG. 7, is displayed on the display panel 3 (Step S23). As shown in FIG. 7, it is clearly indicated on the insufficient battery power screen 32 that the amount of the electric power that remains in the battery 80 is not sufficient for the data conversion. After Step S23 has been performed, the folder display screen that is described above is displayed (Step S19). The converted files that were created before the amount of the electric power that remains in the battery 80 became insufficient for the data conversion are thus displayed in list form on the folder display screen.

In a case where a convertible file does not exist in the specified folder (NO at Step S13), a conversion impossible screen that indicates that the data conversion cannot be performed is displayed on the display panel 3 (Step S25). After Step S25 has been performed, the folder display screen that is described above is displayed (Step S19). The converted files that were created while there were still convertible files that were stored in the specified folder are thus displayed in list form on the folder display screen.

When the folder display screen is displayed at Step S19, the LED display portion 7 is controlled such that it displays an ordinary pattern (in this case, a state in which the light is off), and the operations of the keys in the operation portion 6 are enabled. After Step S19 has been performed, the processing returns to Step S1. Thus the data conversion (Steps S5 to S19) is performed in the same manner as described above every time one of the specified performed actions (that is, the disconnecting of the USB cable 9 and the insertion of the memory card 30) is detected (Steps S1 and S3), until the power supply of the portable terminal 1 is turned off.

As explained above, in the portable terminal 1 in the present embodiment, when the electronic file in the other data format is acquired from the memory card 30, the determination is made as to whether the amount of the electric power that remains in the battery 80 is at least the voltage threshold value. In a case where the amount of the electric power that remains in the internal battery 80 is at least the voltage threshold value, the acquired electronic file is converted into the electronic file in the specified data format, which is then stored in the memory card 30. In a case where the amount of the electric power that remains in the internal battery 80 is less than the voltage threshold value, the acquired electronic file is not converted into the electronic file in the specified data format.

It is therefore possible, when the electronic file in the other data format is being converted into the electronic file in the specified data format in the portable terminal 1, to limit the occurrence of cases where the data conversion is terminated because the amount of the electric power that remains in the battery 80 has become insufficient. This in turn makes it possible to limit the number of cases in which an incompletely converted file is stored in the memory card 30. Moreover, the determination as to whether the amount of the electric power that remains in the battery 80 is sufficient for the data conversion is made every time that the electronic file in the other data format is acquired from the memory card 30. This makes it possible to utilize to the maximum extent the amount of the electric power that remains in the battery 80 and to perform the data conversion for a greater number of the electronic files, even in a case where there are limits on the amount of electric power that can be used by the portable terminal 1 and on the hardware resources.

Note that the display device according to the present disclosure is not limited to the embodiment that is described above, and modifications can be made within the scope of the present invention. In the embodiment that is described above, the portable terminal 1 in which the image display is done on the electrophoretic display panel 3 is used as an example, but the display device is not limited to this example. For example, a display device may also be used in which the image display is done on a known liquid crystal display or the like. A non-portable type of display device such as a digital photo frame or the like may also be used.

In the embodiment that is described above, the pre-conversion electronic file and the converted electronic file are both stored in the memory card 30. This eliminates the need to provide a storage device for storing the pre-conversion electronic file and the converted electronic file separately in the portable terminal 1, and it also makes the portable terminal 1 slimmer and lighter in weight, reduces the manufacturing cost, and the like. The form in which the various types of files are stored in the display device is not limited to this example.

For example, a built-in memory may be provided for storing the various types of files in the portable terminal 1. Both the pre-conversion electronic file and the converted electronic file may be stored in the built-in memory. The storage device in which the pre-conversion electronic file is stored and the storage device in which the converted file is stored may also be different devices. For example, the pre-conversion electronic file may be stored in the memory card 30, and the converted file may be stored in the built-in memory.

In the embodiment that is described above, the converted file is stored in the storage folder in the memory card 30, but the storage location of the converted file is not limited to this example. For example, the converted file may also be stored in the root directory of the memory card 30. The converted files that are stored in the storage folder are displayed in list form on the folder display screen at Step S19, but the converted files may also be selectably displayed. For example, the converted file that is stored in the root directory may also be selectably displayed on the folder display screen.

In the embodiment that is described above, in the data conversion processing that is shown in FIG. 6, the unselected files are selected as the conversion object files one at a time (Steps S107, S111, S113). When the conversion of the one selected conversion object file is completed, one conversion object file is selected next (Steps S107, S111, S113). The number of the conversion object files that are selected at Steps S107, S111, and S113 may be any specified number, and the specified number is not limited to being 1. For example, a plurality of the conversion object files may be selected at one time as the specified number of the conversion object files, and the specified number of the conversion object files that are selected may also be changed.

The apparatus and methods described above with reference to the various embodiments are merely examples. It goes without saying that they are not confined to the depicted embodiments. While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. A display device comprising:
an internal battery that supplies electric power to the display device;
a data acquisition portion that acquires an incompatible data file from a first storage portion that stores at least one incompatible data file, the incompatible data file being an electronic file in a data format that is different from a specified data format;
a remaining power determination portion that determines whether an amount of electric power that remains in the internal battery is at least a specified threshold value;
a data conversion portion that is capable of converting the incompatible data file that is acquired by the data acquisition portion into an electronic file in the specified data format to create a converted file, and that converts the incompatible data file into the electronic file in the specified data format in a case where it has been determined by the remaining power determination portion that the amount of electric power that remains in the internal battery is at least the specified threshold value, and that does not convert the incompatible data file into the electronic file in the specified data format in a case where it has been determined by the remaining power determination portion that the amount of electric power that remains in the internal battery is less than the specified threshold value; and
a storage control portion that stores, in a second storage portion, the converted file that is created by the data conversion portion.

2. The display device according to claim 1, wherein:
the remaining power determination portion, in a case where the converted file has been stored in the second storage portion, determines whether the amount of electric power that remains in the internal battery is at least the specified threshold; and
the data acquisition portion, in a case where it has been determined by the remaining power determination portion that the amount of electric power that remains in the internal battery is at least the specified threshold value, acquires another incompatible data file that has not yet been acquired by the data acquisition portion from the first storage portion.

3. The display device according to claim 1, further comprising:
a completion determination portion that determines whether the conversion by the data conversion portion has been completed; and
a data deletion portion, in a case where it has been determined by the completion determination portion that the conversion has been completed, deletes from a common storage portion that includes the first storage portion and the second storage portion the incompatible data file for which the conversion has been completed,
wherein
the data acquisition portion, in a case where the incompatible data file for which the conversion has been completed has been deleted by the data deletion portion, acquires another incompatible data file that has not yet been acquired by the data acquisition portion from the common storage portion.

4. The display device according to claim 1, further comprising:
an external power supply connection portion adapted to connects to an external power supply and receives electric power supplied from the external power supply,
wherein
the data conversion portion, in a case where the external power supply is connected to the external power supply connection portion, converts the incompatible data file into the electronic file in the specified data format regardless of whether it has been determined by the remaining power determination portion that the amount of electric power that remains in the internal battery is at least the specified threshold value.

5. The display device according to claim 1, wherein
the data acquisition portion acquires the incompatible data file from the first storage portion in an order of a file size, starting with the incompatible data file for which the file size is the smallest.

6. The display device according to claim 4, wherein:
the data acquisition portion acquires the incompatible data file from the first storage portion in accordance with a specified prioritized order; and
the data acquisition portion changes the specified prioritized order according to whether the external power supply is connected to the external power supply connection portion.

7. The display device according to claim 6, wherein:
the data acquisition portion, in a case where the external power supply is not connected to the external power supply connection portion, acquires the incompatible data file from the first storage portion in an order of a file size, starting with the incompatible data file for which the file size is the smallest; and
the data acquisition portion, in a case where the external power supply is connected to the external power supply connection portion, acquires the incompatible data file from the first storage portion in accordance with a specified prioritized order that is different from the order in the case where the external power supply is not connected.

8. The display device according to claim 3, further comprising:
a medium connection portion in which the common storage portion can be connected and from which the common storage portion can be removed, the common storage portion being a storage medium that can be connected in and removed from a plurality of devices.

9. The display device according to claim 3, further comprising:
a display control portion that, in a case where it has been determined by the completion determination portion that the conversion has been completed, displays the electronic file that is stored in the second storage portion.

10. A data conversion method that is implemented in a display device that is provided with an internal battery that supplies electric power, the data conversion method comprising the steps of:
acquiring an incompatible data file from a first storage portion that stores at least one incompatible data file, the incompatible data file being an electronic file in a data format that is different from a specified data format;
determining whether an amount of electric power that remains in the internal battery is at least a specified threshold value;
converting the acquired incompatible data file into an electronic file in a specified data format to create a converted file, in a case where it has been determined that the amount of electric power that remains in the internal battery is at least the specified threshold value; and
storing the converted file in a second storage portion.

11. The data conversion method according to claim 10, wherein:
the determination of whether the amount of electric power that remains in the internal battery is at least the specified threshold value is made, in a case where the converted file has been stored in the second storage portion; and
another incompatible data file that has not yet been acquired is acquired from the first storage portion, in a case where it has been determined that the amount of electric power that remains in the internal battery is at least the specified threshold value.

12. The data conversion method according to claim 10, further comprising the steps of:
determining whether the converting of the incompatible data file has been completed; and
deleting the incompatible data file for which the converting has been completed from a common storage portion that includes the first storage portion and the second storage portion, in a case where it has been determined that the conversion has been completed,
wherein
another incompatible data file that has not yet been acquired and that is stored in the common storage portion is acquired, in a case where the incompatible data file for which the conversion has been completed has been deleted.

13. The data conversion method according to claim 10, wherein
the incompatible data file is converted into the electronic file in the specified data format in a case where the display device is connected to an external power supply, regardless of whether it has been determined that the amount of electric power that remains in the internal battery is at least the specified threshold value.

14. The data conversion method according to claim 10, wherein
the incompatible data file is acquired from the first storage portion in an order of a file size, starting with the incompatible data file for which the file size is the smallest.

15. The data conversion method according to claim 10, wherein:
the incompatible data file is acquired from the first storage portion in accordance with a specified prioritized order; and
the specified prioritized order is changed according to whether the display device is connected to an external power supply.

16. The data conversion method according to claim 15, wherein:
the incompatible data file is acquired from the first storage portion in an order of a file size, starting with the incompatible data file for which the file size is the smallest, in a case where the display device is not connected to the external power supply; and
the incompatible data file, in a case where the display device is connected to the external power supply, is acquired from the first storage portion in accordance with a specified prioritized order that is different from the order in the case where the external power supply is not connected.

17. The data conversion method according to claim 10, further comprising the steps of:
displaying the electronic file that is stored in the second storage portion, in a case where it has been determined that the converting of the incompatible data file has been completed.

18. A computer-readable medium that stores a data conversion program, the program comprising instructions that cause a computer of a display device that is provided with an internal battery that supplies electric power to perform the steps of:
acquiring an incompatible data file from a first storage portion that stores at least one incompatible data file, the incompatible data file being an electronic file in a data format that is different from a specified data format;
determining whether an amount of electric power that remains in the internal battery is at least a specified threshold value;
converting the acquired incompatible data file into an electronic file in a specified data format to create a converted file, in a case where it has been determined that the amount of electric power that remains in the internal battery is at least the specified threshold value; and
storing the converted file in a second storage portion.

19. The computer-readable medium according to claim 18, wherein:
the determination of whether the amount of electric power that remains in the internal battery is at least the specified threshold value is made, in a case where the converted file has been stored in the second storage portion; and
another incompatible data file that has not yet been acquired is acquired from the first storage portion, in a case where it has been determined that the amount of electric power that remains in the internal battery is at least the specified threshold value.
